(19) United States
(12) Patent Application Publication
(10) Pub. No.: US 2011/0244439 A1
(43) Pub. Date: Oct. 6, 2011

(54) Testing System and Method for Mobile Devices

(75) Inventors: Martin Patrick Reed, Franklin, TN (US); Michael James McFarren, Brentwood, TN (US); Armando de Oliveira Fortuna, Franklin, TN (US); Jessica Kane Murphy, Cincinnati, OH (US)

(73) Assignee: RANDA Solutions, Inc., Nashville, TN (US)

(21) Appl. No.: 13/043,967

(22) Filed: Mar. 9, 2011

Related U.S. Application Data
(60) Provisional application No. 61/312,022, filed on Mar. 9, 2010.

(51) Int. Cl. G09B 5/00

(52) U.S. Cl. 434/350

(57) ABSTRACT

A system and method for creating and administering tests on a mobile wireless device are provided, comprising a server containing a plurality of question items in predetermined subject matter areas. A teacher having with a mobile wireless device and teacher access credentials to the server creates and administers a test containing selected question items for selected students. Each student having a mobile wireless device and student access credentials to the server provides responses to the question items on the test as administered by the teacher. After taking the test, the student transmits the student's responses to the server. Teachers and other authorized users can then assess the student's performance on the test, along with other performance statistics provided in reports across a plurality of students' responses to various question items and tests.

### CROSS-REFERENCE TO RELATED APPLICATIONS

This nonprovisional patent application claims priority under 35 U.S.C. 5119 to U.S. Provisional Application Ser. No. 61/312,022, filed on Mar. 9, 2010.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### BACKGROUND OF THE INVENTION

1. Field of the Invention

The present invention relates to systems and methods for designing and administering tests for students in an educational environment, and more particularly to such systems and methods enabled for use on computers or mobile wireless devices.

2. Description of Related Art

Modern communication technology and mobile wireless devices have enabled persons to depart from conventional methods of acquiring and delivering information. The prevalence and speed of Internet-based content have revolutionized virtually every industry and service, including law, medicine, engineering, and education. Specifically, in the education field, teachers and students are no longer tied to classrooms and physical facilities, because the educational content can so easily be provided over remote devices (wired or wireless) in the form of video lectures, lesson plans, notes, and study guides. However, despite these advances, viable solutions for administering tests to students on a remote basis remain elusive.

To the extent that mobile testing has been tried in recent years, such efforts have focused largely on institutions of higher learning. Technical challenges, software and communication complexities, and hardware expense have resulted in slow adoption of these technologies. In those instances where it has been successful, the typical users are substantially more technologically inclined than the broader public. If mobile testing is to become more commonplace, it will have to appeal to administrators, teachers, and students who prefer proven hardware and a more usable, simpler interface.

Ideally, mobile testing systems and methods should satisfy a number of important requirements. First, such a testing system should make aggregated assessment data accessible and comprehensible to administrators and teachers. Also, the system should fully embrace wireless devices over a secure network using standard communication protocols. It should also be simple to use for all participants to promote reliability in test questions and responses, including sufficient security features to minimize cheating. Furthermore, the testing system should manage all user and testing data on servers that afford robust and scalable deployment in small and large school systems. And finally, the system must employ common and inexpensive hardware and software for maximum accessibility across a wide spectrum of schools, teachers, and students. It is believed that the present invention meets all of the above requirements.

### SUMMARY OF THE INVENTION

Therefore, an educational testing system for mobile devices is provided, comprising a server for storing selected information; an administration computer connected to the server for controlling access by users; a teacher computer connected to the server for assigning question items to tests, and for assigning tests to selected users; one or more wireless mobile devices connected to the server via a wireless connection, wherein each wireless mobile device presents question items to the user; and wherein the user's responses to the question items is stored on the server.

Preferably, the teacher computer is also a wireless mobile device. Also, in a preferred embodiment, the server stores one or more question sets in a plurality of subject matter areas, wherein each of the question sets includes a plurality of question items selectable for each test.

Assuming suitable access credentials, the teacher computer enables selection of question items from the question sets. The teacher computer also enables creation of new question items and editing of existing question items, wherein each question item includes foils having a single correct answer. More preferably, the teacher computer enables creation of new passages related to question items and editing of existing passages, as well as the creation of new tests and editing of existing tests.

In a broad embodiment of the invention, the teacher computer enables administration of a test to selected users, and wherein each user has one of the mobile wireless devices. In most cases, each test is enabled for a predetermined date and time, analogous to conventional student testing.

The teacher computer enables viewing of responses to question items provided by each user and performance statistics related to responses by one or more users. Optionally, the question items and tests are created and administered in accordance with state education standards.

At the server level, the server stores a user access database, and wherein predetermined features are allowed or disabled based upon the user's login credentials.

Responses by each user are stored on the mobile wireless device and transmitted to the server. The server then provides access by authorized users to reports compiling the responses and related performance statistics.

In another embodiment, the selected question items include feedback information dependent upon the response.

Also preferably, the server provides one or more tests to a user having test taking credentials, wherein the tests correspond to predetermined tests selected by the teacher computer for the specific user. The user selects responses to the question items in the test, and then confirms completion and transmission of the responses from the mobile wireless device.

A method for creating and administering tests on a mobile wireless device is also provided, comprising: providing a server containing a plurality of question items in predetermined subject matter areas; providing a teacher with a mobile wireless device and teacher access credentials to the server to create and administer a test containing selected question items for selected students; providing the selected students with a mobile wireless device and student access credentials to the server to take the test; transmitting the student's responses to the question items to the server; and assessing the student's performance on the test.

The method may further comprise the step of providing the teacher with the ability to select question items in accordance with state education standards.

The method may also further comprise the step of enabling the teacher to create new question items and edit existing question items, wherein each question item includes foils having a single correct answer.

In another embodiment, the method may further comprise the step of enabling the teacher to create new passages related to question items and edit existing passages, as well as enabling the teacher to edit existing tests.

Preferably, the method also comprises the step of providing performance statistics related to the performance of: (a) specific students on selected question items and tests, and (b) a plurality of students on selected question items and tests.

A mobile educational device is also provided, comprising a housing; a display connected to the housing; memory operatively contained within the housing; a wireless transmitter for sending and receiving wireless communication signals from a server; an input device for enabling responses from a student; and wherein the device receives educational question items from a server, presents the question items to the student on the display, records the responses to the question items from the student, and transmits the responses to the server via the wireless transmitter.

The device preferably enables a user having teacher access credentials to edit the question items and tests, and also administer one or more tests to selected students.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1A shows a schematic diagram of the relationship between participants of the system in accordance with a preferred embodiment of the present invention

FIG. 1B shows an exemplary flowchart of steps in creating and editing the tests, taking the test, and reporting results in accordance with one embodiment of the invention.

FIG. 2 shows a login user interface for the system.

FIG. 3 shows the “Home” tab of the user interface for the system.

FIG. 4 shows the “Items” tab of the user interface for the system.

FIG. 5 shows an interface for creating and editing items.

FIG. 6 shows an interface for adding foils to an item.

FIG. 7 shows the interface of FIG. 6 when the foil is the correct answer.

FIG. 8 shows an interface for inserting an image to an item.

FIG. 9 shows an interface for selecting subject matter areas before managing and editing items.

FIG. 10 shows an interface for managing and editing items.

FIG. 11 shows an interface for viewing usage statistics for an item.

FIG. 12 shows the “Passages” tab of the user interface for the system.

FIG. 13 shows an interface for creating and editing passages for an item.

FIG. 14 shows an interface for entering details about a passage.

FIG. 15 shows the “Tests” tab of the user interface for the system.

FIG. 16 shows a first interface for entering basic information about a test.

FIG. 17 shows a second interface for selecting items to include in the test.

FIG. 18 shows a third interface for placing items in a desired order for a test.

FIG. 19 shows an interface for editing details about a test.

FIG. 20 shows the “Administrations” tab of the user interface for the system.

FIG. 21 shows a first interface for entering details about a test administration, including start and end times.

FIG. 22 shows an interface for selecting an existing test for editing or administration.

FIG. 23 shows a second interface for selecting students to whom the test will be administered.

FIG. 24 shows an interface for viewing and editing existing test administrations.

FIG. 25 shows an interface for viewing statistics about students to whom a particular test has been administered.

FIG. 26 shows a more detailed interface for viewing a student's responses to specific items on an administered test.

FIG. 27 shows an interface of available tests presented to a student after a successful student login.

FIG. 28 shows an interface for a sample question item presented to a student.

FIG. 29 shows the interface of FIG. 28 with the addition of the item's associated passage.

FIG. 30 shows an interface enabling the student to submit the test responses or continue taking the test.

FIG. 31 shows an interface providing immediate results to the student with item-specific feedback information.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

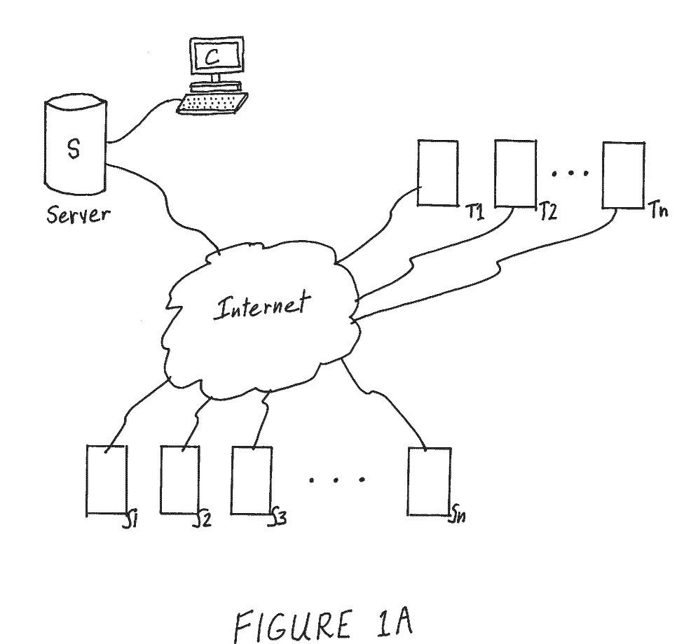

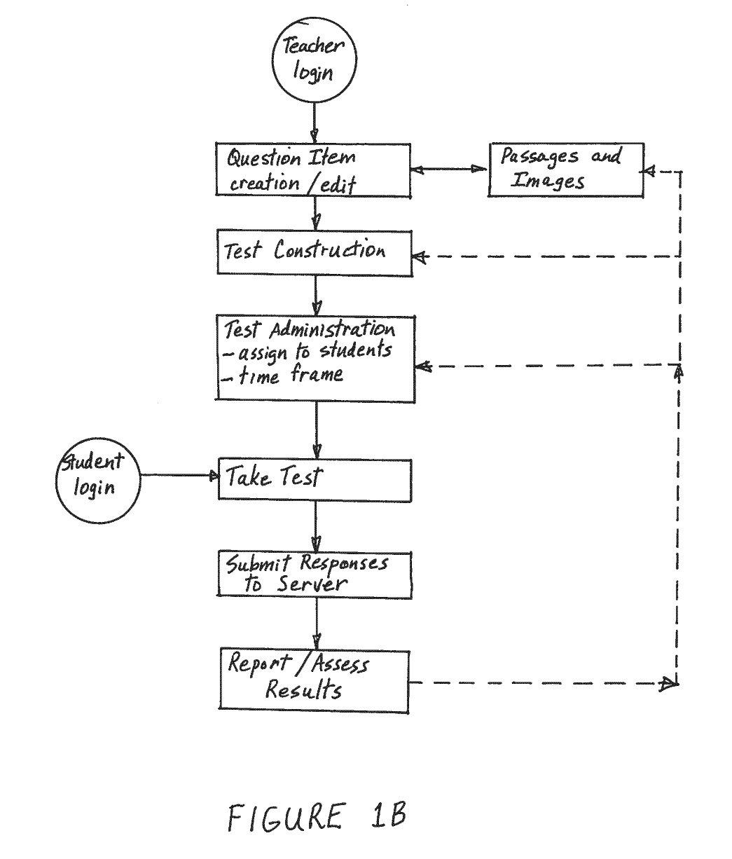

Turning now to FIG. 1A and FIG. 1B, in a preferred embodiment of the present invention, a testing system for mobile devices is shown to generally comprise a server S for storing and delivering selected information; an administration computer C connected to the server S for controlling access by users; one or more teacher computers Tn connected to the server S for assigning question items to tests, and for assigning tests to selected users; and one or more wireless mobile devices, S1 through Sn, connected to the server via a wireless connection, wherein each wireless mobile device presents question items to the user. Wireless communications between all participants can be over the Internet, preferably using industry standard browser technology and suitable security protocols. In a preferred embodiment, the system is web-enabled such that access to the system's login interface is simply a matter of directing the browser to the correct system web site. The teacher computers Tn may also be mobile wireless devices, similar to or identical to the student devices Sn.

The server S stores one or more question sets in a plurality of subject matter areas, as well as any other data used by the participants, including but not limited to, user access data, responses to test questions, test administration details, reports and statistics, and student information.

Each mobile wireless device may be any device capable of communicating wirelessly in a manner known to those in the art, and having a display suitable to presenting test items and allowing user responses. Although many mobile wireless devices are possible, one example of such a device may be an iPhone or iPad manufactured by Apple, Inc.

FIG. 1B depicts a typical flowchart of steps in a preferred embodiment of the invention, wherein a teacher creates and edits question items and one or more tests, and then makes such tests available to students. The administrator or teacher logs into the system using a username and password, and the authentication credentials enable a menu of options matched to that level of authorization. In the case of teachers and other workers requiring edit capabilities, such persons need the ability to create and edit question items, answers, tests, and administrations, as well as manage reports and other data generated from the tests. Each of these functions will be described in more detail below with respect to the figures.

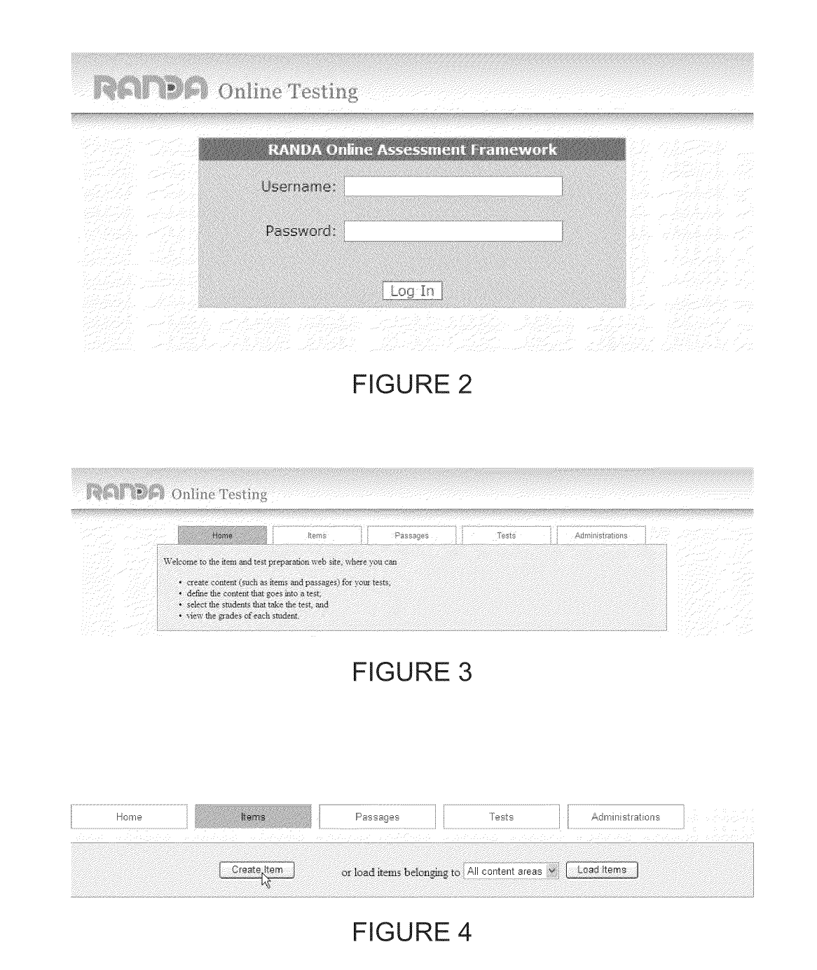

As depicted in FIG. 2, when a person uses the system, an login interface appears requesting a user name and password. If the user has the appropriate credentials, such as “Item Writer”, “Test Administrator”, or “Test Taker”, then a Home interface is presented to the user, along with a number of tabs for various functions, as shown in FIG. 3. The specific functions available will change based on the users credentials, e.g. Item Writers are not permitted to administer tests.

The first step in preparing tests using the system is item creation. An item comprises a question and its foils (or answer choices). An item may also have a passage attached, and the passage may contain reference information such as an article, a book excerpt, math formulae, or other content necessary for the user to consider prior to providing a response. As shown in FIG. 4, when the “Items” tab is selected, an interface is displayed with an option to create an item. Preferably, the interface also includes an option to load existing items in all subject matter (or Content Matter) areas, or in only selected Content Matter areas, such as math, English, or social studies.

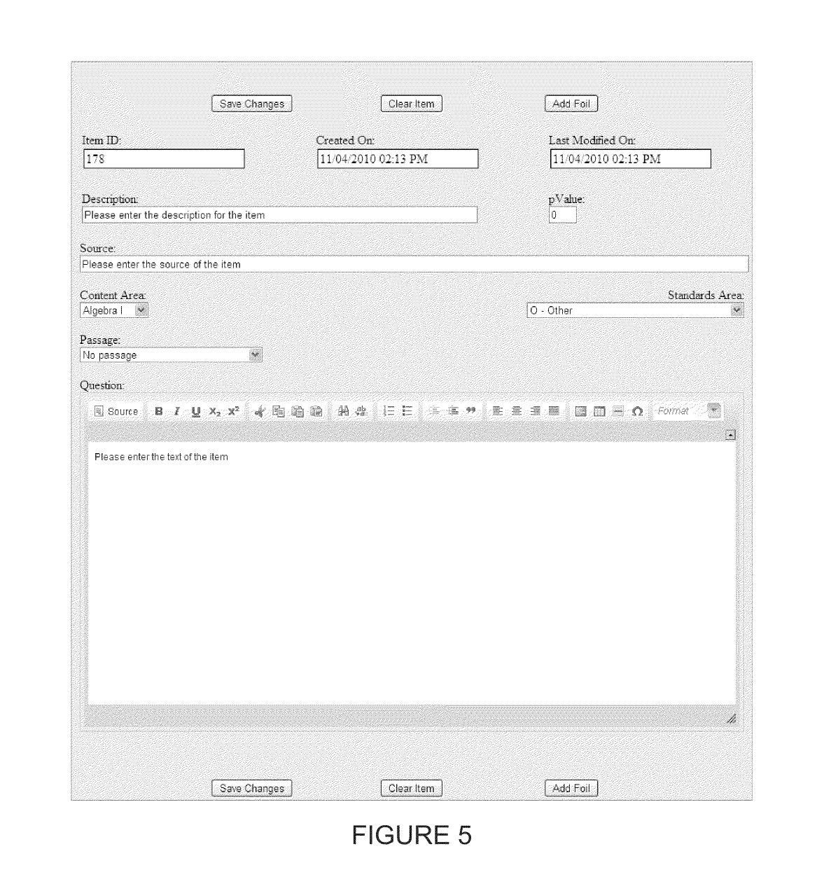

If the user desires to create a new item, an interface such as depicted in FIG. 5 will be displayed. Various fields in the interface are provided to identify the item and manage its information. For example, Item ID is automatically generated, and provides a unique identifier for each item for bookkeeping purposes. Created On is automatically generated as a timestamp of when the item was created. Last Modified On is also automatically generated as a timestamp of the last time the item was edited. Description enables a textual description to help the user identify the item prior to considering whether to use it in a test. pValue is a probability ranging from zero to one that gives statistical meaning to the item and can be entered if available. Source is the item's source (e.g. a textbook or sample test or the author's name). Content Area is the subject matter or course name associated with an item. Standards Area is the particular standard associated with the Content Matter selected. Passage is an optional selection for additional content that the test taker may need to provide responses to the item, as explained above. Existing passages may simply be selected from a drop-down list, or they can be created as explained below. Question is a textual section that comprises the primary testing content of the item, and a range of formatting functions are available to the user, along with an option to upload an image to the item.

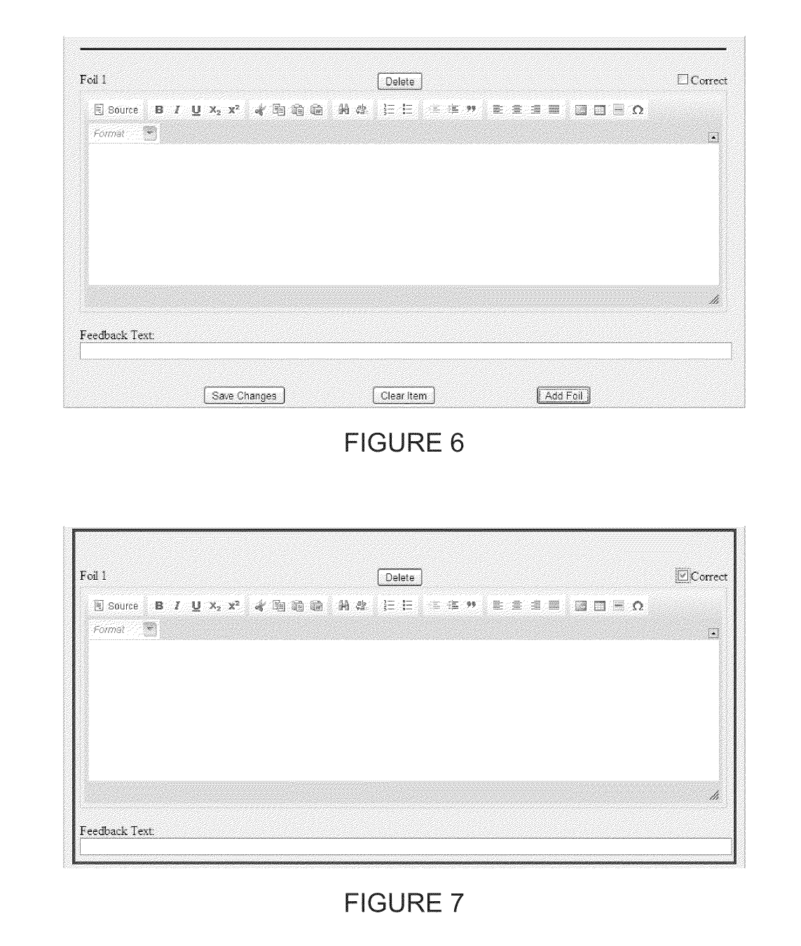

Additional buttons are provided for Save Changes, Clear Item, and Add Foil, of which the first two are self-explanatory. The Add Foil button, however, expands the page with an open text field with formatting functions, as illustrated in FIG. 6. Again, the user has the option of uploading images associated with a foil, as well as a feedback note that offers helpful information about why a response is correct or incorrect.

FIG. 7 depicts the manner in which a foil is indicated as the correct answer by selecting a Correct box, after which the foil is highlighted by a colored box. When the desired changes are made and feedback notes added, the foil is saved as explained above by selecting the Save Changes button.

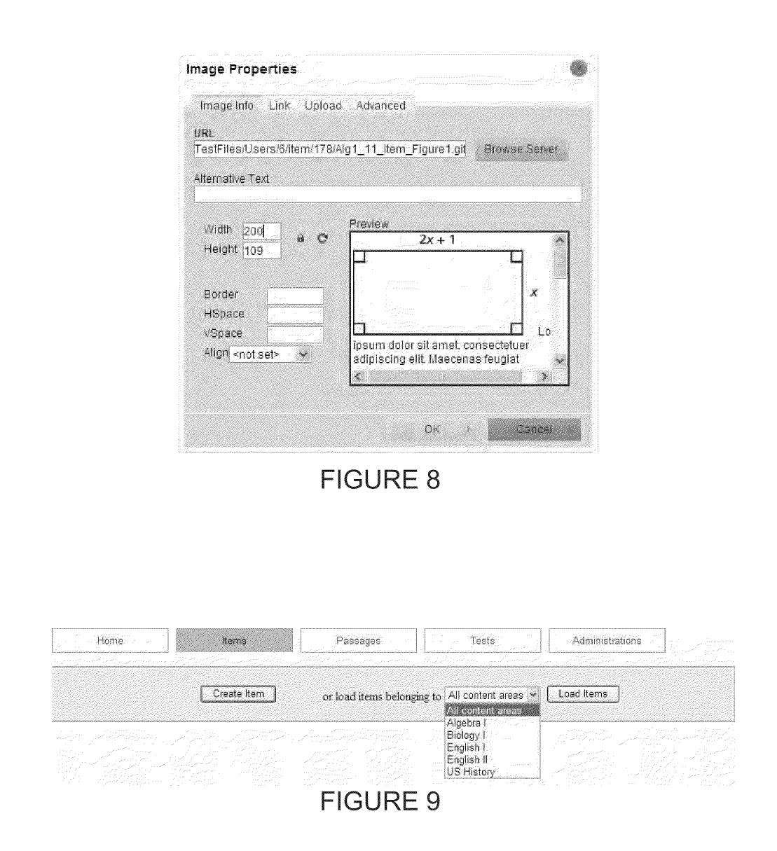

As shown in FIG. 8, if the image icon is selected, another interface opens to enable uploading of an image from the device's memory. Basic image formatting features are provided to allow resiting and alignment of the image as desired. When the image is satisfactory to the user, it can be sent to the server for use in connection with the item or foil.

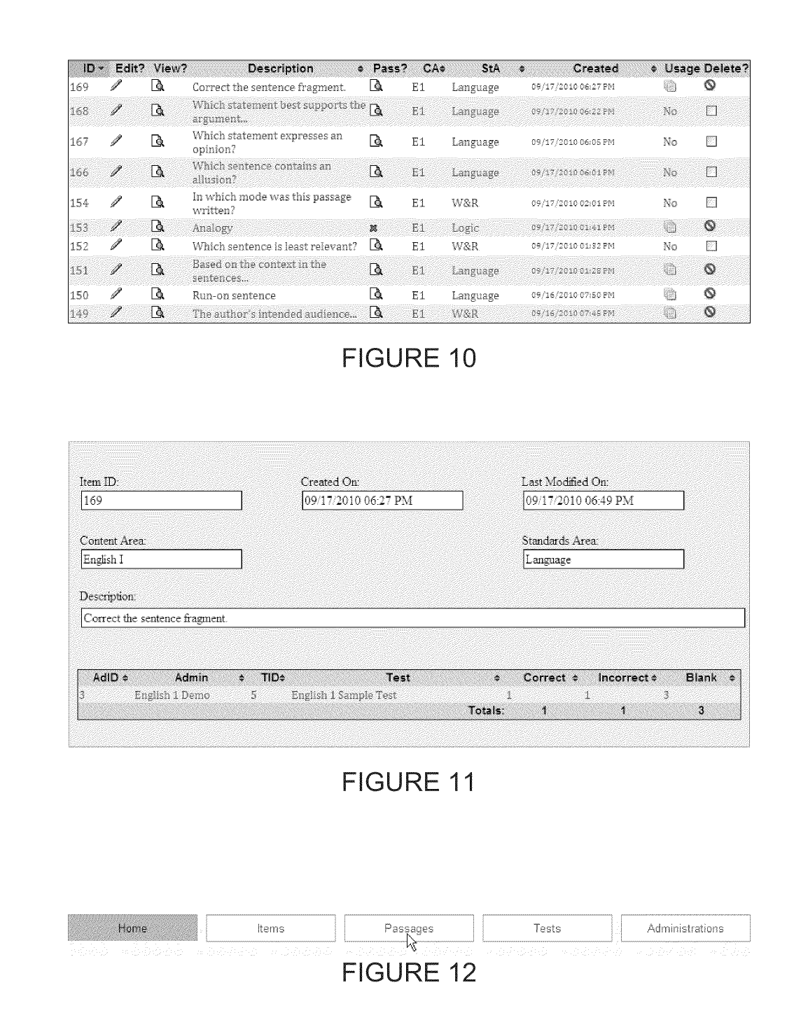

If other items need to be edited, they can be loaded by selection of the Load Items button as shown in FIG. 9. All items in the database may be loaded without regard to content area, although the user may select a specific content area from a drop-down list and load only those items. The list of items available for editing is then displayed as shown in FIG. 10, and the user may sort the items by selecting the desired column heading. Any items may be edited by selecting the pencil icon in the Edit column Likewise, the passage associated with any item may be viewed by selecting the icon under the Pass column. The Usage column indicates whether usage statistics are available for viewing for each item. If the item has been used on tests, selection of the usage icon provides a display of information about the item, as shown in FIG. 11, including the name of the test and the number of times that the response was correct, incorrect, or left blank. Finally, by selecting the box under the Delete column, items can be deleted from the list if they have not been used on tests.

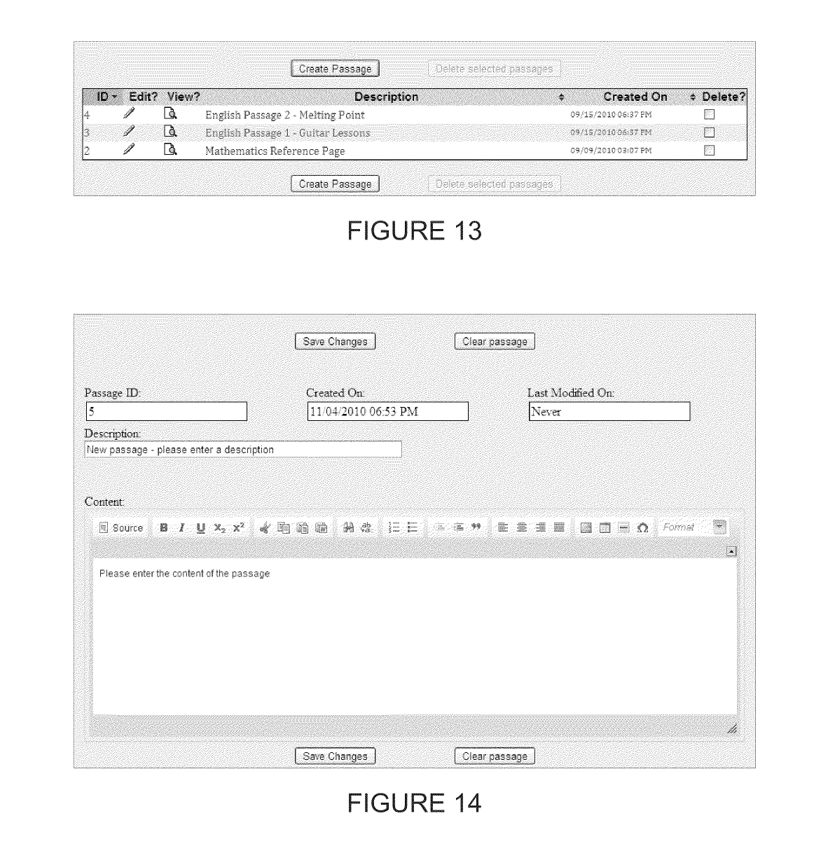

If the user wishes to create, edit, and assign passages to items, the “Passage” tab can be selected from the system's main display, as shown in FIG. 12. FIG. 13 shows a list of existing passages is displayed for viewing, editing, or deletion, along with a Create Passage button. Again, the displayed list can be sorted via the column headings as is common in the art. When a passage is created or edited, a display of available fields is shown as in FIG. 14. As described earlier, images can be uploaded and adjusted for inclusion with the passage. Importantly, the system software and hardware are also capable of displaying passages or other portions of the screen on a projector system. Thus, a proctor for a particular test can project a passage to a group of students in a room as students are working through the test.

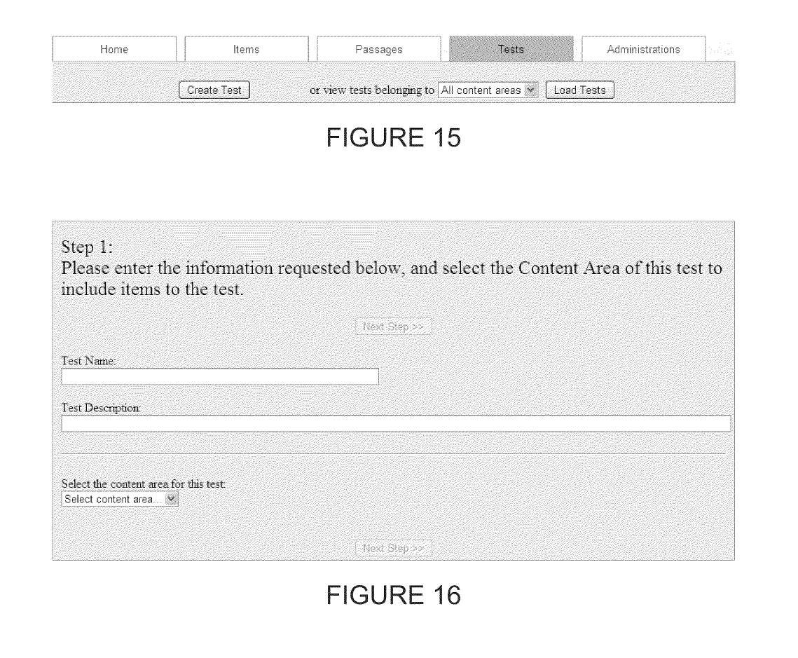

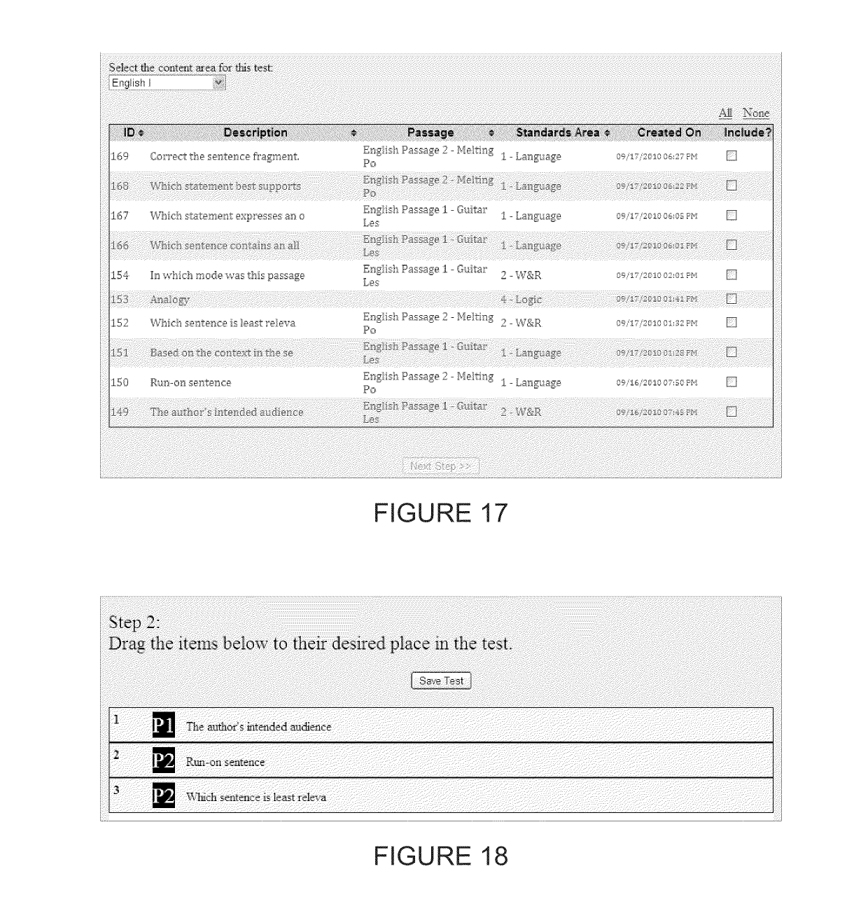

Once a suitable number and variety of items, foils, and passages are available on the server in one or more content areas, an actual test can be created and edited, similar to the manner in which items and passages are managed. From the main system page, the “Tests” tab is selected as shown in FIG. 15. The Create Test button can be selected for the creation of a new test, or existing tests can be loaded by content areas available from a drop-down list and selecting Load Tests. For a new test, an initial display shown in FIG. 16 requests the name of the test, its description, and the content area with which it will be associated. Upon completion of these fields, a Next Step button becomes available. Selection of that button causes a list of items associated with the chosen content area to appear, e.g. English I, as shown in FIG. 17. Items and their associated passages can easily be included by selecting a box adjacent to the item.

After selection of the desired items for the test, another Next Steps button is selectable, which displays a list of those items selected for the test, as shown in FIG. 18. On this interface, the selected items can be placed in the desired order by dragging and dropping items in the appropriate places. Icons indicating the passage number for each items, such as P1, P2, etc., are conveniently displayed next to the item so that items having common passages may be gathered together in groups for the test. When the ordering step is completed, a Save Test button can be selected to finalize the test before administration.

Ordering items for a specific test is perhaps the most common and useful method of constructing the test. However, it is within the spirit and scope of the invention that adaptive testing methods may also be employed. For example, suitable artificial intelligence (AI) can be employed within the system that will present items to a student based upon the student's response to one or more previous questions. Thus, if the AI detects that responses are correct on more basic items, additional items of a more complex nature may be presented to the student. Likewise, if the AI detects that responses are incorrect, the student may be presented with items of a more basic or remedial nature to enable teachers to understand more precisely where the student's strengths and weaknesses may lie for certain subject matter.

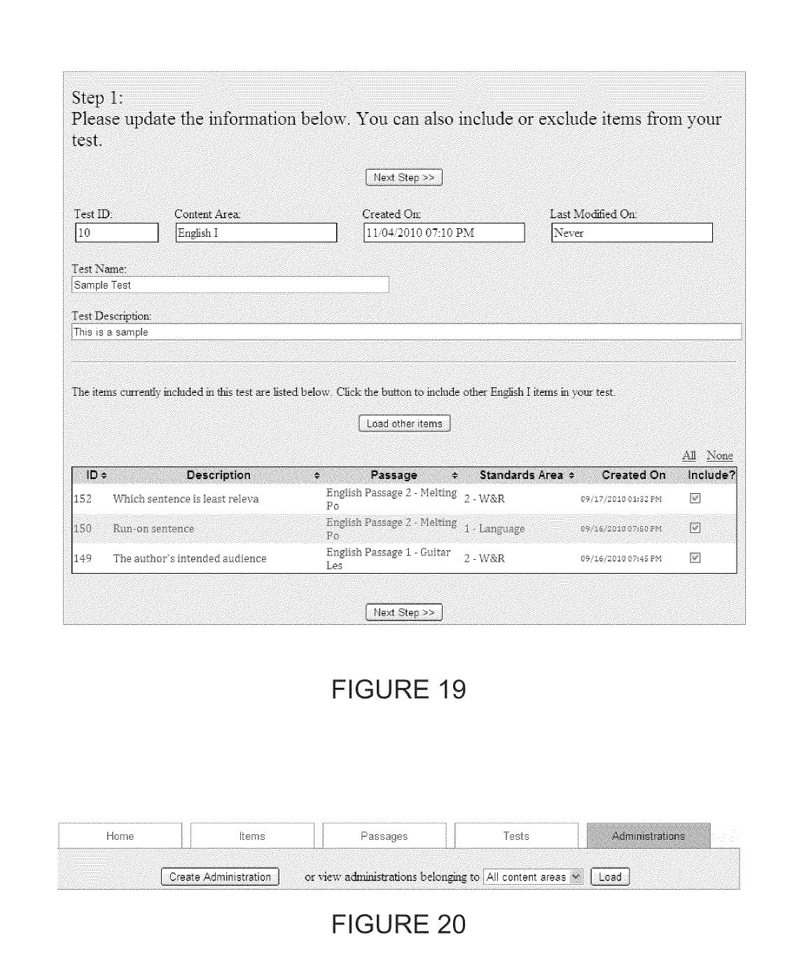

Referring back to FIG. 15, previously created tests can be edited by loading them from a drop-down list. From the list of tests, the pencil icon for a particular test can be selected, which causes a test editing interface to be displayed to the user, as shown in FIG. 19. Items can then be added, excluded, and reordered as explained above before saving the edited test to the server.

Once test creation is complete, any of the tests can be administered to students. From the main system display, the “Administration” tab is selected as shown in FIG. 20. Similar to other tabs on the main system display, new administrations can be created with the Create Administration button, or existing administrations can be loaded by the Load button after selection from a drop-down list.

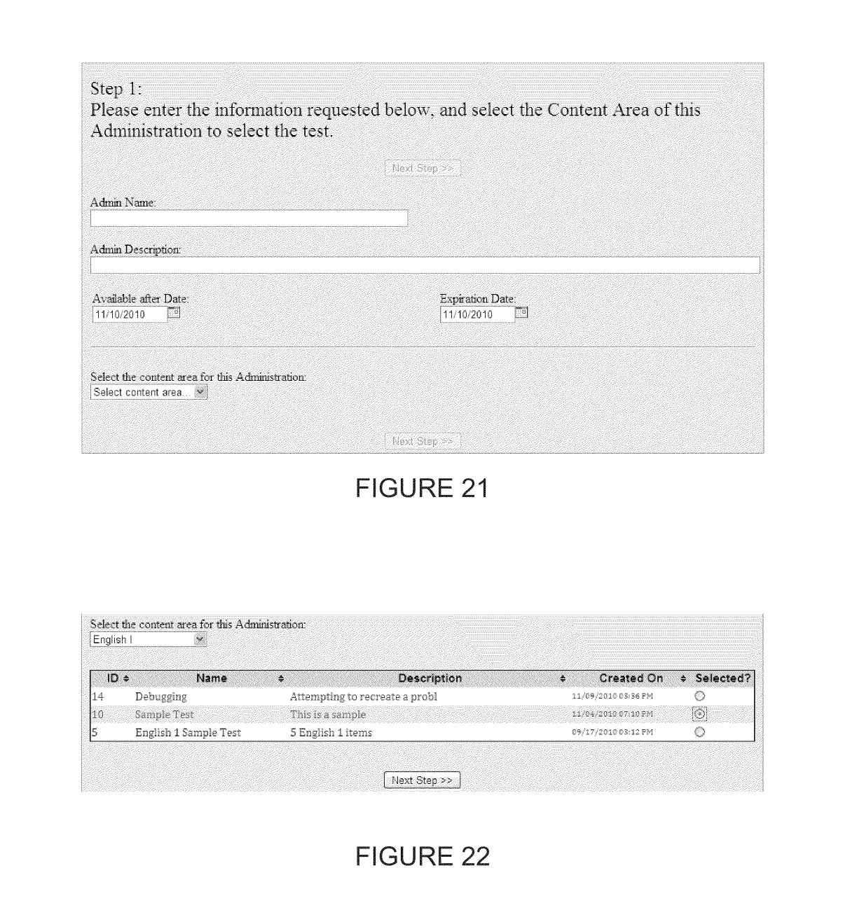

FIG. 21 shows an interface for the creation of a new administration, which includes windows of available dates. In other words, the test will become available to students no earlier than the Available after Date, and no later than the Expiration Date. Preferably, date selection is accomplished by a pop-up calendar as is common in many software applications. Furthermore, in addition to the test window, the test can be administered such that assessment data can be available in relatively small time intervals, such as ten minutes. Also, the content area in which the test will administered is also selected from a drop-down list on the interface. Once a content area has been selected, the interface expands to show a list of previously created tests for that specific content area, as shown in FIG. 22. The desired test is then selected, which enables the Next Steps button for further definition of the administration.

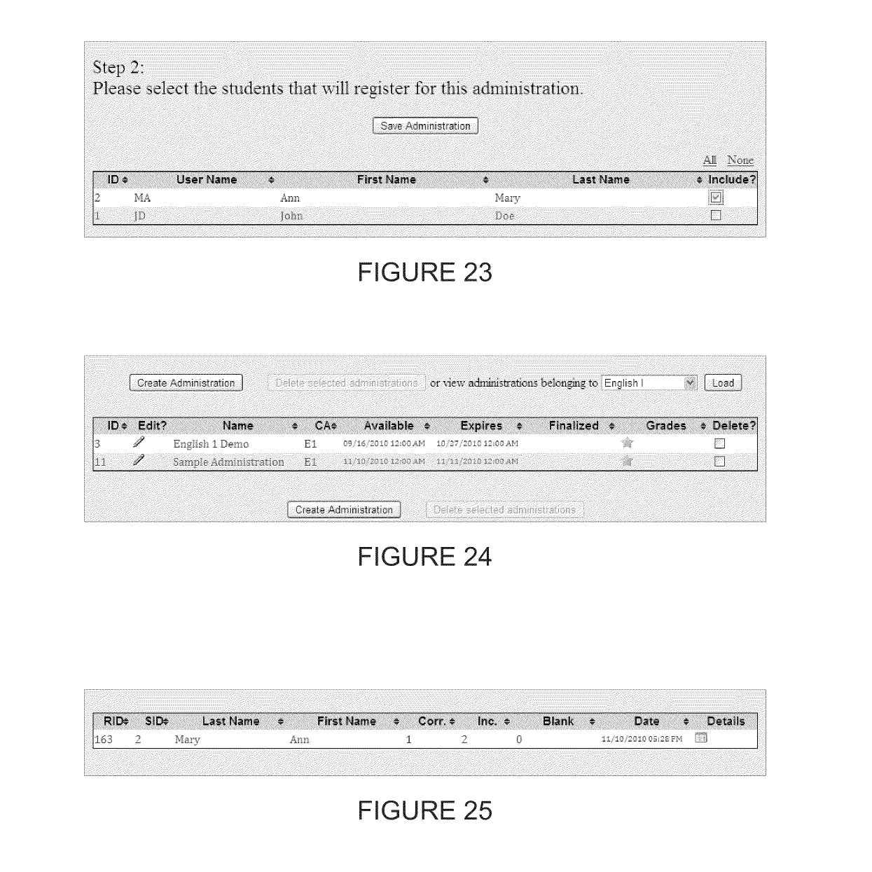

After selection of the Next Steps button, a list of students is displayed, as shown in FIG. 23, so that the test can be made available only for the students which are selected. Preferably, the list of students displayed would only be those who are enrolled in the course corresponding to the content area related to the test. Selections are made by checking an Include box adjacent to the student name. When the student selection is complete, the user selects the Save Administration button to complete the administration process until the test if taken. A notification or message to the user that the administration has been completely successful may also be displayed.

Editing administrations is similar to editing other items, and existing administrations can be loaded by content area from the main “Administrations” tab. Once the list of administrations is displayed, as shown in FIG. 24, they can be edited with respect to any of the attributes established during the creation step.

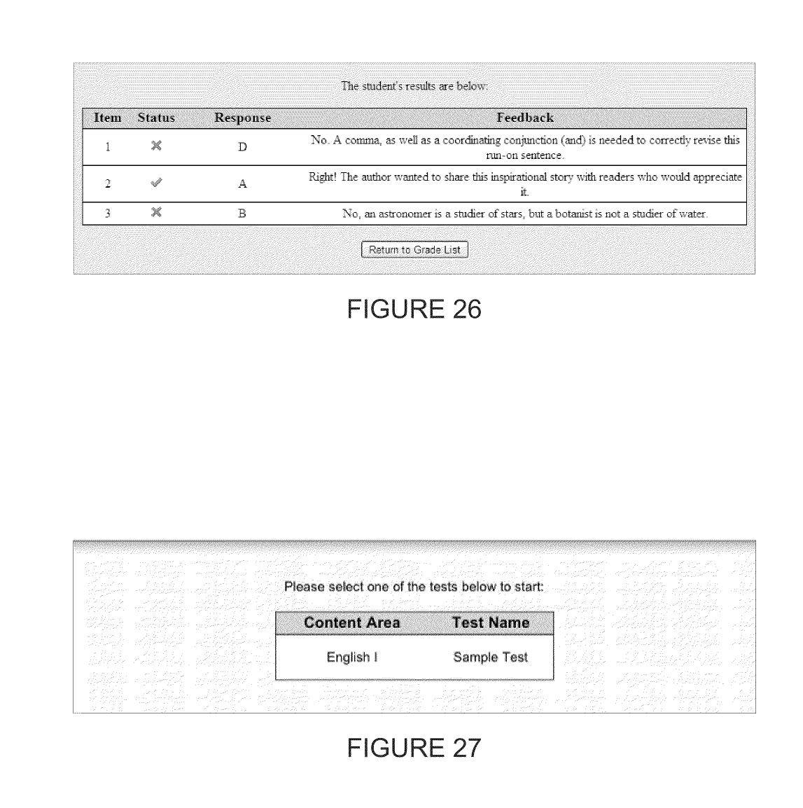

Importantly, in the list of existing administrations, a Grades column is shown which may include an icon, such as a star, indicating that a student has taken the test and submitted responses. Selecting the star icon causes a display of the students who have taken the test, along with information regarding the test date, and the number of correct, incorrect, and blank responses, as shown in FIG. 25. Under the Details column, selection of the Details icon causes the display of item numbers, status, responses, and also any feedback delivered to the student as defined in the item's creation, as shown in FIG. 26. Selecting Return to Grade List reverts back to list of students who took the test.

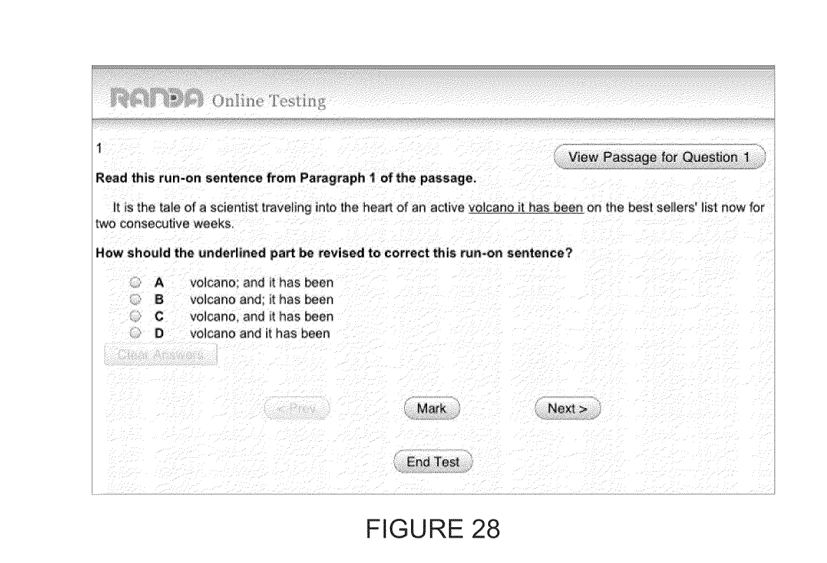

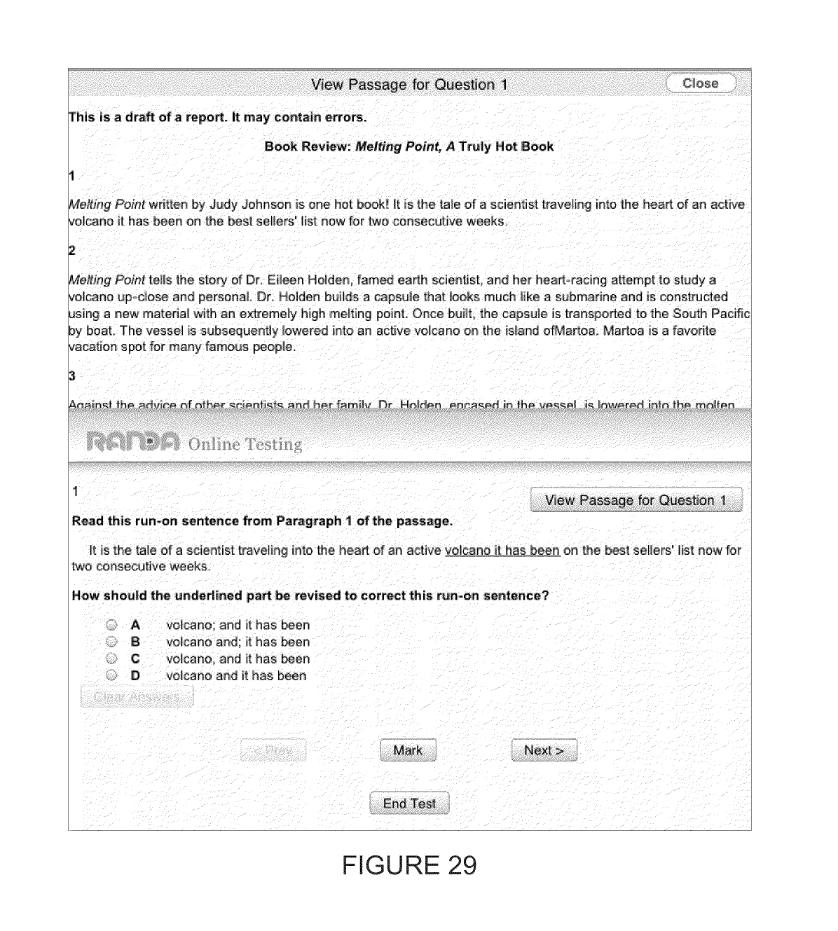

From the perspective of the student, when a student needs to take an available test, the student logs into the system from the mobile wireless device with the appropriate user name and password. Once the students credentials have been verified, a list of available tests is displayed to the student, as shown in FIG. 27, preferably sorted by content area and the name of the test. Upon selection of the desired test, the display changes to the first question item, as shown in FIG. 28, along with the possible options for response. The student then selects the appropriate radio button from the choices and then selects the Next button. Advantageously, the system implements a “save state” upon the selection of each response, such that if the students exists the application prematurely or accidently, the student can still resume progress with those responses already made. If the student wishes to clear the radio buttons of the response, then the Clear Answers button can be selected. If the student wishes to skip the item and come back to it before submitting the final responses, the Mark button can be selected, which then places a reminder to the student to address that specific item before completing the test. Items that are marked can likewise be unmarked using the Unmark button. For each item, a View Passage button is also provided for those items which have associated passages. When the View Passage button is selected, the associated passage is displayed, as shown in FIG. 29, and can be removed from the display with the Close button.

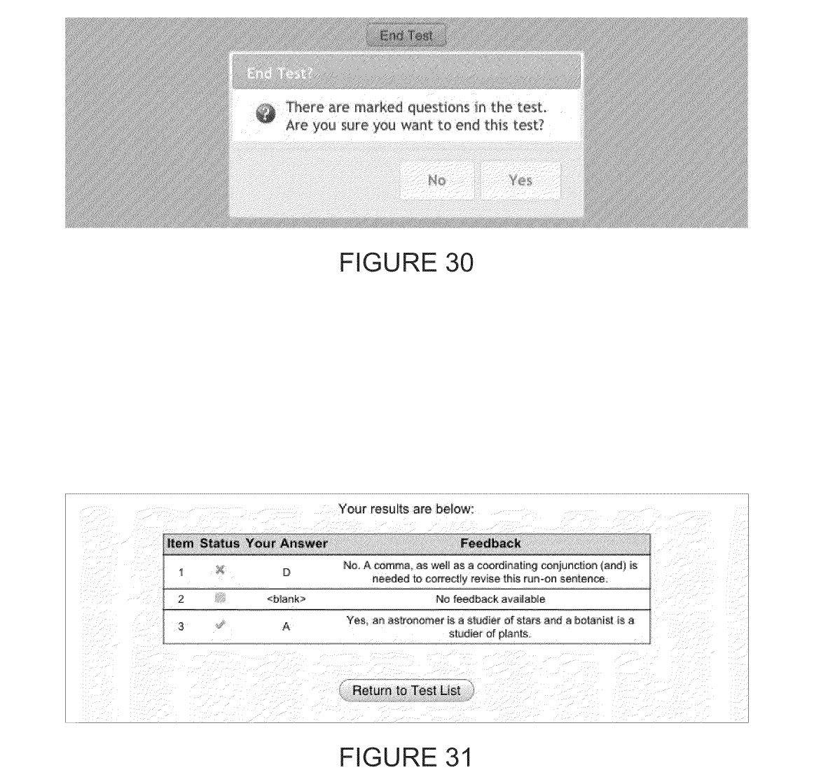

When the student is ready to complete the test, regardless of whether any items have been left blank, the student selects the End Test button, at which time a confirmation display as shown in FIG. 30, is presented to the student. Once the student confirms that he is finished, the test responses temporarily stored on the mobile wireless device are transmitted to the server. In a preferred embodiment, the display then provides the list of test items, along with the students responses, their status as correct, incorrect, or blank, and any feedback notes related to the response, as shown in FIG. 31. Once the user exits the application, the test is preferably locked until the authorized teacher releases the test again, if necessary. This can be done by the teacher when he is online with the system, or possible over the mobile wireless device via login authentication.

In addition to the novel features of the system and method described above, a number of other capabilities would be desirable to administrators, teachers, parents, and students. For example, when the mobile wireless devices used with the system do not have a working wireless connection, data stored locally on the mobile devices cannot be synchronized with the server. Therefore, the system is capable of automatically synchronizing such data as soon as a working connection is detected, without the user having to take other action. Such a feature is built into the system without regard to any specific hardware platform (device independence), and the synchronization details are based upon an activation code particular to a specific mobile device. Thus, only data relevant to that device is transferred, in keeping with access credentials for the user in possession of that device. By using activation codes in this manner, teacher assignments and other data can be pushed to the device based on the needs of the specific user.

Importantly, the system supports dynamic content, and a wide range of software languages can be implemented. For example, a specific passage might include video, HTML content, a computer-aided design (CAD) drawing, or some other dynamic content created from software from any number of sources. Also, the system would support translation features, such as those provided by Google.

The system further enables the creation of user groups whose access and edit rights can share: (a) items for test construction, (b) constructed tests, (c) results of item performance on a de-identified basis, (d) constructed test performance on a de-identified basis, and any number of other shared features and results that can be defined for groups having common interests or needs in the testing environment. Such a feature is particular useful for administrators at the district level, school level, and for parents having students in a specific school, because all such users are able to see informative trends with respect to the subject matter, item questions, and constructed tests.

Another scenario in which the system and methods will be especially useful are in situations requiring mobile labs, such as geographical areas which are remote or unable to establish network connections due to catastrophic events or natural disasters. In those instances, a mobile lab vehicle with a satellite connection is able to provide a base for wireless communication with any number of mobile wireless devices, and then transmit data synchronized with such mobile lab to the server via the satellite connection.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The invention claimed is:

1. An educational testing system for mobile devices, comprising:
(a) a server for storing and delivering selected information;
(b) an administration computer connected to the server for controlling access by users;
(c) a teacher computer connected to the server for assigning question items to tests, and for assigning tests to selected users;
(d) one or more wireless mobile devices connected to the server via a wireless connection, wherein each wireless mobile device presents question items to the user; and
(e) wherein the user's responses to the question items is stored on the server.

2. The system of claim 1, wherein the teacher computer is a wireless mobile device.

3. The system of claim 1, wherein the server stores one or more question sets in a plurality of subject matter areas.

4. The system of claim 3, wherein each of the question sets includes a plurality of question items selectable for each test.

5. The system of claim 1, wherein the teacher computer enables selection of question items from the question sets.

6. The system of claim 1, wherein the teacher computer enables creation of new question items and editing of existing question items, wherein each question item includes foils having a single correct answer.

7. The system of claim 1, wherein the teacher computer enables creation of new passages related to question items and editing of existing passages.

8. The system of claim 1, wherein the teacher computer enables creation of new tests and editing of existing tests.

9. The system of claim 1, wherein the teacher computer enables administration of a test to selected users, and wherein each user has one of the mobile wireless devices.

10. The system of claim 9, wherein each test is enabled for a predetermined date and time.

11. The system of claim 1, wherein the teacher computer enables viewing of responses to question items provided by each user and performance statistics related to responses by one or more users.

12. The system of claim 1, wherein the question items and tests are in accordance with state education standards.

13. The system of claim 1, wherein the server stores a user access database, and wherein predetermined features are allowed or disabled based upon the user's login credentials.

14. The system of claim 1, wherein the responses by each user are stored on the mobile wireless device and transmitted to the server.

15. The system of claim 1, wherein the server provides access by authorized users to reports compiling the responses and related performance statistics.

16. The system of claim 1, wherein selected question items include feedback information dependent upon the response.

17. The system of claim 1, wherein the server provides one or more tests to a user having test taking credentials, wherein the tests correspond to predetermined tests selected by the teacher computer for the specific user.

18. The system of claim 17, wherein the user selects responses to the question items in the test, and then confirms completion and transmission of the responses from the mobile wireless device.

19. A method for creating and administering tests on a mobile wireless device, comprising:
(a) providing a server containing a plurality of question items in predetermined subject matter areas;
(b) providing a teacher with a mobile wireless device and teacher access credentials to the server to create and administer a test containing selected question items for selected students;
(c) providing the selected students with a mobile wireless device and student access credentials to the server to take the test;
(d) transmitting the student's responses to the question items to the server; and
(e) assessing the student's performance on the test.

20. The method of claim 19, further comprising the step of providing the teacher with the ability to select question items in accordance with state education standards.

21. The method of claim 19, further comprising the step of enabling the teacher to create new question items and edit existing question items, wherein each question item includes foils having a single correct answer.

22. The method of claim 19, further comprising the step of enabling the teacher to create new passages related to question items and edit existing passages.

23. The method of claim 19, further comprising the step of enabling the teacher to edit existing tests.

24. The method of claim 19, further comprising the step of providing performance statistics related to the performance of: (a) specific students on selected question items and tests, and (b) a plurality of students on selected question items and tests.

25. A mobile educational device, comprising:
a housing;
a display connected to the housing;
memory operatively contained within the housing;
a wireless transmitter for sending and receiving wireless communication signals from a server;
an input device for enabling responses from a student; and
wherein the device receives educational question items from a server, presents the question items to the student on the display, records the responses to the question items from the student, and transmits the responses to the server via the wireless transmitter.

26. The device of claim 25, wherein the device enables a user having teacher access credentials to edit the question items and tests.

27. The device of claim 25, wherein the device enables a user having teacher access credentials to administer one or more tests to selected students.
